(19) United States
(12) Patent Application Publication
(10) Pub. No.: US 2025/0121461 A1
(43) Pub. Date: Apr. 17, 2025

(54) BONDING MATERIAL AND BONDED STRUCTURE

(71) Applicant: Panasonic Intellectual Property Management Co., Ltd., Osaka (JP)

(72) Inventors: YUMI TAKAO, Hyogo (JP); KIYOHIRO HINE, Osaka (JP); AKIO FURUSAWA, Osaka (JP); SHINJI ISHITANI, Hyogo (JP); HIROHISA HINO, Osaka (JP)

(21) Appl. No.: 18/982,596

(22) Filed: Dec. 16, 2024

Related U.S. Application Data
(63) Continuation of application No. PCT/JP2023/022242, filed on Jun. 15, 2023.

(30) Foreign Application Priority Data
Jul. 5, 2022 (JP) 2022-108539

(51) Int. Cl. B23K 35/02; B23K 35/26; B23K 35/30; B23K 35/362

(52) U.S. Cl. CPC B23K 35/0244; B23K 35/262; B23K 35/302; B23K 35/362

(57) ABSTRACT

A bonding material includes: a single particle that is a particle of a first metal; a composite particle including a central core that is a particle of the first metal, and at least one coating layer covering an entire surface of the central core, the at least one coating layer including a fine particle of a second metal; and a flux including a reducing agent component, in which the first metal and the second metal have properties of forming an intermetallic compound of the first metal and the second metal, and the reducing agent component of the flux is present between the central core and the at least one coating layer.

### TECHNICAL FIELD

The present disclosure relates to a bonded structure having a structure in which two members are bonded by a bonding material containing a metal material, which is used in an equipment such as a power device, and a bonding material used for manufacturing the bonded structure.

### BACKGROUND ART

An equipment having a semiconductor element with heat generation such as a power device may have a bonded structure in which two members of a substrate and a heat dissipation portion are bonded to each other for heat transport from the substrate on which the semiconductor element is mounted to the heat dissipation portion for the purpose of dissipating heat generated from the semiconductor element.

In recent years, as power devices, from the viewpoint of energy saving, use of next generation power device elements such as SiC elements and GaN elements having an advantage that power can be controlled with high efficiency has increased from conventional Si elements. These next-generation power device elements have an advantage of being able to operate even at high temperatures, and can withstand more heat generation than conventional Si elements, so that control with a larger current may be performed. However, when a larger current flows, a calorific value from the semiconductor element increases, and the semiconductor element is exposed to a higher temperature. As a result, a temperature Tⱼ of a bonding portion between an electrode such as a lead frame for flowing a current controlled by the semiconductor element and an element electrode also increases. For example, the temperature Tⱼ of the bonding portion is about 125° C. when a conventional Si element is used, but reaches 200° C. to 250° C. when a SiC element and a GaN element are used.

Therefore, the bonding portion between the element electrode and the lead frame electrode is required to have thermal conductivity for efficiently releasing generated heat to the lead frame and heat resistance to withstand a higher temperature Tⱼ of the bonding portion.

Conventionally, a solder material has been widely used as a bonding material used for the bonding portion of a bonded structure for bonding the element electrode and the lead frame electrode with a conductor because bonding can be performed at a low temperature. However, 200° C. to 250° C., which is the temperature Tⱼ of the bonding portion when the SiC element and the GaN element are used, is a temperature near or higher than the melting point for the solder material containing Sn, Pb, or the like as a main component, which is generally used, and is a very severe temperature. Therefore, in the bonded structure using these solder materials for the bonding portion, it is difficult to secure heat resistance when the SiC element and the GaN element are used.

In order to solve such a problem, a transient liquid-phase (TLP) bonding method has been proposed. In the TLP bonding, a high melting point metal and a low melting point metal are brought into contact with each other to melt the low melting point metal, and interdiffusion therebetween forms an intermetallic compound with the high melting point metal. As a result, the remelting temperature of the bonding portion is increased by the bonding temperature, and the maximum operating temperature can be made higher than the bonding temperature. However, there is a problem that a long heating time is required because the interdiffusion takes a long time.

In order to solve such a problem, a method of shortening the time for interdiffusion by using a high melting point metal as nanoparticles has been proposed. However, the nanoparticles have a large surface energy, and when mixed with a low melting point metal as a bonding material, the nanoparticles adhere to a surface of the low melting point metal and completely encapsulate or coat the surface of the low melting point metal, so that there is a problem that the meltability of the low melting point metal is deteriorated and the strength of the bonding portion is weakened.

As a bonding material that solves such a problem, a technique is disclosed in which meltability is secured by using metal particles in which fine particles containing any of Ag, Cu, Bi, or Ge as a high melting point metal are deposited and attached in an island shape on a surface of Sn or an alloy of Sn and Cu having an average particle size of 5 μm as a low melting point metal (See, for example, PTL 1.).

### CITATION LIST

### Patent Literature

PTL 1: Unexamined Japanese Patent Publication No. 2011-177719

### SUMMARY OF THE INVENTION

A bonding material according to an aspect of the present disclosure includes: a single particle that is a particle of a first metal; a composite particle including a central core that is a particle of the first metal, and at least one coating layer covering an entire surface of the central core, the at least one coating layer including a fine particle of a second metal; and a flux including a reducing agent component, in which the first metal and the second metal have properties of forming an intermetallic compound of the first metal and the second metal, and the reducing agent component of the flux is present between the central core and the at least one coating layer.

### BRIEF DESCRIPTION OF THE DRAWINGS

FIG. 1 is a diagram illustrating an example of a metal particle of a first exemplary embodiment.

FIG. 2 is a cross-sectional SEM image of a bonding material of an example of the present exemplary embodiment after heating.

FIG. 3 is a cross-sectional SEM image of a bonding material of a comparative example of the present exemplary embodiment after heating.

FIG. 4 is a table showing proportions of the mass of first metal particles and the mass of second metal particles to the total mass of metals contained in a bonding material paste in Example 1 and Comparative Example 1, and results of the above evaluation.

FIG. 5 is a table showing proportions of the mass of first metal particles and the mass of second metal particles to the total mass of metals contained in a bonding material paste in Example 2 and Comparative Example 2, and results of the above evaluation.

FIG. 6 is a table showing average particle sizes of a composite particle and a single particle of the first metal particles in Example 3, and results of the above evaluation.

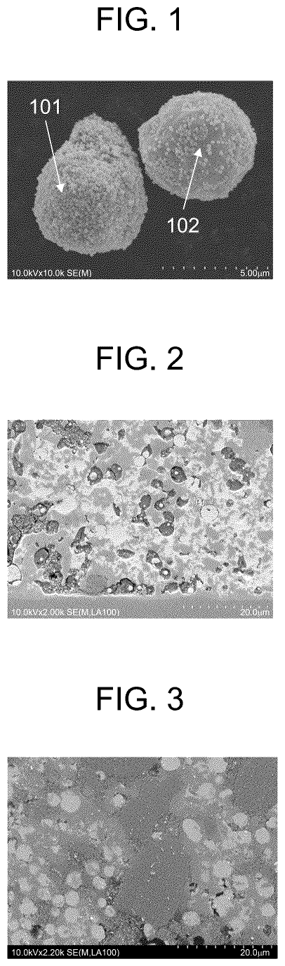

### DESCRIPTION OF EMBODIMENT

### Background to Present Disclosure

In a bonding material for bonding an element electrode and a metal member by TLP bonding of metal, if the content of a high melting point metal in fine particles to be attached in an island shape increases, a surface of a low melting point metal is encapsulated or coated. Therefore, it is necessary to reduce the content of the fine particles. In this case, the entire amount of the low melting point metal cannot form an intermetallic compound, and the low melting point metal remains in a bonding portion, and there is a problem that it is difficult to secure heat resistance of the bonding portion.

The present inventors have studied a bonding material containing a low melting point metal in two forms of single particles and composite particles as a bonding material for bonding an element electrode and a metal member by TLP bonding of metal. Each of the single particles is a particle of a first metal of the low melting point metal. Each of the composite particles includes a central core that is the particle of the first metal, and at least one coating layer covering the entire surface of the central core, the coating layer including fine particles of a second metal that is a high melting point metal. The bonding material contains a certain amount of a content of the high melting point metal in the fine particles, and the single particles and the composite particles sufficiently contain the low melting point metal. The present inventors have studied a bonded structure in which an element electrode and a metal member are bonded by the bonding material containing the composite particle and the single particle.

Since the bonding material contains fine particles of the second metal which is a high melting point metal, the time required for bonding can be shortened, and thermal damage to peripheral members at the time of bonding can be suppressed. On the other hand, the first metal that is a low melting point metal exists as the single particle and the central core of the composite particle. In particular, the fine particles of the second metal covering the central core of the composite particle and the first metal react to form an intermetallic compound. Furthermore, the single particle becomes a liquid phase by heating to become a parent phase of the composite particle, and contributes to the generation of the intermetallic compound. Thereby, the intermetallic compound having a high melting point can be obtained, and heat resistance can be obtained.

A bonding material layer formed of the bonding material is heated to a temperature greater than or equal to a temperature (Hereinafter, the liquid phase generation temperature is referred to as “liquid phase generation temperature”.) at which a liquid phase including the first metal is generated even in part to form a liquid phase including the first metal, and the first metal and the second metal in the composite particles are reacted to generate an intermetallic compound. At this time, a bonding layer in which the composite particles are connected to each other by the intermetallic compound generated by reacting the first metal contained in the single particle with the second metal on a surface of the composite particles is formed. As a result, the present inventors have found that the element electrode and the metal member can be bonded by the bonding layer having high bonding strength and heat resistance, and have completed the present disclosure.

The present disclosure solves the conventional problems, and an object of the present disclosure is to provide a bonding material having excellent strength and heat resistance of a bonding portion.

A bonding material according to a first aspect includes: a single particle that is a particle of a first metal; a composite particle including a central core that is a particle of the first metal, and at least one coating layer covering an entire surface of the central core, the at least one coating layer including a fine particle of a second metal; and a flux including a reducing agent component, in which the first metal and the second metal have properties of forming an intermetallic compound of the first metal and the second metal, and the reducing agent component of the flux is present between the central core and the at least one coating layer.

In the bonding material according to a second aspect, in the first aspect, the first metal may be a Sn alloy.

In the bonding material according to a third aspect, in the first or second aspect, the second metal may be Cu.

In the bonding material according to a fourth aspect, in the first or third aspect, the first metal may be a Sn—Bi alloy.

In the bonding material according to a fifth aspect, in the fourth aspect, the Sn—Bi alloy may include Bi with a content at which a liquidus temperature is less than or equal to 150° C. in an equilibrium diagram of the Sn—Bi alloy.

In the bonding material according to a sixth aspect, in the fourth aspect, the Sn—Bi alloy may include Bi with a content of 52 mass % to 62 mass %.

In the bonding material according to a seventh aspect, in any one of the first to sixth aspects, the fine particle of the second metal in a total mass of the single particle and the composite particle may be 30 mass % to 40 mass % when the total mass is 100 mass %.

In the bonding material according to an eighth aspect, in any one of the first to seventh aspects, the particle of the first metal that is the central core of the composite particle may have an average particle size of 2 μm to 10 μm.

In the bonding material according to a ninth aspect, in any one of the first to eighth aspects, the particle of the first metal that is the single particle may have an average particle size of 2 μm to 38 μm.

In the bonding material according to a tenth aspect, in any one of the first to ninth aspects, the fine particle of second metal may have an average particle size of 50 nm to 500 nm.

In the bonding material according to an eleventh aspect, in any one of the first to tenth aspects, the reducing agent component may be an alkanolamine.

A bonded structure according to a twelfth aspect includes an element electrode, a metal member, and the bonding material according to any one of the first to eleventh aspects, which bonds the element electrode and the metal member.

As described above, according to the bonding material according to the present disclosure, by shortening the time required for bonding, it is possible to provide a bonding material in which thermal damage to a peripheral member at the time of bonding is reduced, deterioration of meltability at the time of heating due to use of the fine particles is prevented, and strength and heat resistance of a bonding portion are excellent.

Hereinafter, a bonding material and a bonded structure according to an exemplary embodiment of the present disclosure will be described in detail with reference to the accompanying drawings.

### First Exemplary Embodiment

### <Bonding Material>

A bonding material according to a first exemplary embodiment of the present disclosure includes a single particle, a composite particle, and a flux. The single particle is a particle of a first metal. The composite particle includes a central core that is a particle of the first metal, and at least one coating layer coating the entire surface of the central core and including a fine particle of a second metal. The flux includes a reducing agent component. The first metal and the second metal can form an intermetallic compound. Furthermore, the reducing agent component of the flux exists between the central core and the coating layer. By using the composite particle and the single particle, the strength and heat resistance of a bonding portion tend to be improved.

Hereinafter, constituent members used for the bonding material will be described.

### <Single Particle (First Metal Particle)>

The single particle (first metal particle) used in the present disclosure contains, for example, Sn. When the first metal has a low liquid phase generation temperature, a liquid phase is formed by the first metal particle before a second metal particle is sintered, and a strong bonding interface is formed by wetting or chemical reaction with a member to be bonded. In addition, liquid phase diffusion occurs between the liquid phase and the second metal particle, whereby an intermetallic compound can be formed, and a bonding layer having excellent heat resistance is formed. The bonding portion is formed by heating the first metal particle at a temperature greater than or equal to the liquid phase generation temperature of the first metal particle, and the heating temperature is preferably equal to that of conventional solder. Therefore, the liquid phase generation temperature is preferably less than or equal to 150° C. (liquid phase generation temperature≤150° C.).

Such an alloy is preferably a Sn—Bi alloy. The composition of such an alloy is not particularly limited as long as it is a composition in which the liquid phase generation temperature (liquidus temperature) is less than or equal to 150° C., but a composition in which the liquid phase generation temperature (liquidus temperature) is lower is preferable, and a eutectic composition is particularly preferable.

In particular, in a case where the first metal is a Sn—Bi alloy, it is preferable that a liquid phase is easily formed by the first metal, and a bonding layer excellent in bonding strength can be reliably formed. An atomic ratio between Sn and Bi in the Sn—Bi alloy is determined from an equilibrium diagram of the Sn—Bi alloy, and is preferably such that the alloy becomes a liquid phase at 150° C. Specifically, the atomic ratio of Bi in the Sn—Bi alloy is preferably 52 mass % to 62 mass %.

An average particle size of the first metal particle of the single particle is preferably 2 μm to 38 μm. When the average particle size of the first metal of the single particle exceeds an upper limit (38 μm), a large difference in particle size occurs between the single particle and the composite particles, uniform kneading cannot be performed, and the coated particles are aggregated, and the bonding strength tends to decrease. Furthermore, when the average particle size of the first metal of the single particle is less than a lower limit (2 μm), a total surface area of the first metal particle increases, so that an oxide film of the first metal particle increases, and the meltability of the first metal particle tends to deteriorate and the bonding strength tends to decrease.

Note that the average particle size is calculated using a laser particle size distribution meter. The average particle diameter is a value of a median diameter d50% (μm, in terms of volume). The same applies hereinafter.

### <Composite Particle>

An average particle size of the first metal particle as the central core of the composite particle is preferably 2 μm to 10 μm. When the average particle size of the first metal of the composite particle exceeds an upper limit (10 μm), a total surface area of the first metal particle as the central core of the composite particle decreases, the number of second metal fine particles capable of adhering to the surface of the first metal particle decreases, and excessive second metal fine particles exist. The excessive second metal fine particles coat the surface of the single particle to cause a decrease in bonding strength, and the excessive second metal fine particles aggregate in the bonding layer to cause a decrease in reliability of the bonding portion. Furthermore, when the average particle size of the first metal particle as the central core of the composite particle is less than a lower limit (2 μm), the total surface area of the first metal particle increases, so that an oxide film of the first metal particle increases, and the meltability of the first metal particle tends to deteriorate and the bonding strength tends to decrease.

When the total mass of the single particle and the first metal particle as the central core of the composite particle is 100 mass %, a ratio of the single particle is preferably 30 mass % to 60 mass %. When the ratio of the single particle exceeds 60 mass %, the second metal fine particles constituting the composite particle become excessive, and the second metal fine particles aggregate in the bonding layer, so that the reliability of the bonding portion tends to decrease. Furthermore, when the ratio of the single particle is less than 30 mass %, the composite particles cannot be bonded together, so that the strength of the bonding portion tends to decrease.

### <Second Metal Fine Particles>

The second metal is preferably a metal having a higher melting point than the first metal and capable of forming an intermetallic compound with the first metal contained in the first metal, and particularly preferably Cu. An average particle size of the second metal fine particles is preferably 50 nm to 500 nm. When the average particle size of the second metal fine particles exceeds an upper limit (500 nm), a contact area with the first metal particle decreases, and the time required for bonding tends to increase. Furthermore, the average particle size of the second metal fine particles is preferably greater than or equal to 50 nm from the viewpoint of retaining characteristics as a metal.

When the total mass of the single particle and the composite particle is 100 mass %, a ratio of the particle of the second metal is preferably 30 mass % to 40 mass %. When a content of the second metal particle is less than a lower limit (30 mass %), the formation of the intermetallic compound by the liquid phase diffusion reaction between the melted first metal and the second metal particle becomes insufficient, the first metal incapable of forming the intermetallic compound remains in the bonding layer, and the heat resistance of the bonding layer tends to decrease. Furthermore, when the content of the second metal particle exceeds an upper limit (40 mass %), the second metal particle that cannot form the intermetallic compound excessively remain in the bonding layer, and the strength of the bonding layer tends to decrease.

### <Flux>

As the reducing agent component of the flux present between the central core and the coating layer in the composite particle, alkanolamines are preferred. The alkanolamines coat a surface of the first metal particle that is the central core of the composite particle, and the second metal fine particles adhere to the coating layer, whereby a strong bond can be formed.

### <Method of Manufacturing Bonded Structure>

A manufacturing method of the bonded structure according to the first exemplary embodiment includes the following three steps.
(1) A step of forming, by using the bonding material described above, a multilayer body including a first member, a second member, and a bonding material layer that is in contact with surfaces of the first member and the second member and is formed by using the bonding material of the present disclosure.
(2) A step of heating the bonding material layer at a temperature greater than or equal to a liquid phase generation temperature to form a liquid phase composed of the first metal.
(3) A step of reacting the first metal with the second metal to form an intermetallic compound, forming a bonding layer, and bonding the first member and the second member by the bonding layer.

(1) In the bonding method of the present disclosure, first, a multilayer body including a first member, a second member, and a bonding material layer that is in contact with surfaces of the first member and the second member and is formed using the bonding material of the present disclosure is formed. The method of forming such a multilayer body is not particularly limited, and examples thereof include a method in which the bonding material according to the first exemplary embodiment of the present disclosure is printed or applied on the surface of the first member, and the second member is disposed on a surface of the formed bonding material layer.

The first member is not particularly limited as long as the surface is made of metal, and examples thereof include a Cu plate (for example, a semiconductor substrate), a ceramic plate with a metal attached to the surface, and an alloy plate of a Cu alloy, a Ni alloy, or the like. Furthermore, the second member is not particularly limited as long as the surface is made of metal, and examples thereof include a semiconductor element (Si chip, SiC chip, GaN chip) and a metal plate (Cu plate, Ni plate, Al plate).

Furthermore, at least one of a region in contact with the bonding material layer on the surface of the first member and a region in contact with the bonding material layer on the surface of the second member preferably contains a metal capable of generating an intermetallic compound (preferably, an intermetallic compound having a melting point of greater than or equal to 250° C.) by a reaction with at least one of the first metal and the second metal. As a result, the bonding strength between the first member or the second member and the bonding layer is improved. Moreover, in the case of containing a metal capable of generating an intermetallic compound having a melting point of greater than or equal to 250° C., the heat resistance of the bonding layer tends to be improved. Examples of the metal capable of generating the intermetallic compound by reaction with at least one of the first metal and the second metal include Au, Ag, Cu, and Ni. Such metals may be used singly or in combination of two or more kinds thereof. Furthermore, in a case where two or more kinds of metals are used, an alloy may be formed.

(2) and (3) Next, the multilayer body including the first member/bonding material layer/second member thus formed is heated at a predetermined temperature to form a liquid phase including the first metal, and the first metal and the second metal are reacted to generate an intermetallic compound, thereby forming a bonding layer (More preferably, the bonding layer is also excellent in electrical conductivity and thermal conductivity.) having excellent bonding strength.

That is, first, the bonding material layer is heated at a temperature greater than or equal to a liquid phase generation temperature. As a result, a liquid phase is formed by the first metal before the second metal is sintered. The composite particle reacts with the second metal attached to the surface to generate an intermetallic compound, and the single particles spread like a binder between the composite particles having generated the intermetallic compound, and react with the second metal fine particles of an outermost shell of the composite particles to generate the intermetallic compound. As a result, the intermetallic compound is uniformly generated in the bonding layer, and the bonding layer (More preferably, the bonding layer is also excellent in electrical conductivity and thermal conductivity.) excellent in bonding strength is formed.

Furthermore, in the case of using, as at least one of the first member and the second member, a member containing a metal capable of forming an intermetallic compound by a reaction with the first metal in a contact region with the bonding material layer on the surface, the metal contained in the contact region and the first metal react with each other by this heat treatment to further generate the intermetallic compound, so that a bonding layer with further improved bonding strength is formed.

For example, in a case where a semiconductor substrate is used as the first member and a semiconductor element is used as the second member, by the bonding method of the present disclosure, it is possible to manufacture a semiconductor device having excellent bonding strength between the semiconductor element and the semiconductor substrate, the semiconductor device including the semiconductor element, the semiconductor substrate, and a bonding layer disposed between the semiconductor element and the semiconductor substrate and formed using the bonding material. In particular, in the case of using, as at least one (preferably, both) of the semiconductor element and the semiconductor substrate, one containing a metal capable of reacting with the first metal to form an intermetallic compound in the contact region with the bonding layer on the surface, it is possible to manufacture a semiconductor device in which the bonding strength between the semiconductor element and the semiconductor substrate is further improved. Furthermore, in the case of using, as at least one (preferably, both) of the semiconductor element and the semiconductor substrate, one containing a metal capable of reacting with the first metal to form an intermetallic compound having a melting point of greater than or equal to 250° C. in the contact region with the bonding layer on the surface, a semiconductor device further excellent in heat resistance can be manufactured.

### EXAMPLES

Although the present disclosure will be described in detail based on examples, the present disclosure is not limited to these examples.

### Example 1

### 1. Production of Bonded Structure

SnBi particles having an average particle size of 2 μm to 6 μm were prepared as the first metal particle, and Cu nanoparticles having an average particle size of 200 nm were prepared as the second metal particle.

A bonding material was adjusted by mixing the first metal particle and the second metal particle so that the total amount of the first metal particle and the second metal particle was 90 mass % of the total amount of the paste, the amount of triethanolamine as a reducing agent was 2.1 mass %, and the total amount of the organic solvent and the activator was 7.9 mass %. At this time, the first metal particle and the second metal particle were mixed at different ratios to obtain a plurality of bonding materials. In Example 1-1, a proportion of the first metal particle and a proportion of the second metal particle in the total amount of the first metal particle and the second metal particle were set to 60 mass % and 40 mass %, respectively, and in Example 1-2, a proportion of the first metal particle and a proportion of the second metal particle were set to 65 mass % and 35 mass %, respectively, to adjust the bonding material.

In the method of manufacturing a bonding material, first, 50 mass % of the entire first metal particles and triethanolamine were mixed, the surface of the first metal particles was coated with a reducing agent, and then the first metal particles and the second metal particles were mixed to obtain composite particles. The obtained composite particles were kneaded with single particles as a remainder of the first metal particles and a flux to obtain a bonding material paste.

For the bonded structure, oxygen-free Cu was used for the substrate, and a Si chip (electrode-plated Ti/Ni/Au) of 1 mm was used for the component. The bonding material was applied onto the substrate using a metal mask having a thickness of 100 μm, and a Si chip was layered on the obtained bonding material layer.

While a layered surface of the obtained multilayer body was pressurized at 1.36 N, the multilayer body was heated at a firing temperature of 200° C. for 10 minutes in a nitrogen atmosphere at atmospheric pressure to obtain a bonded structure. A rate of temperature increase during the temperature increase was set to 3° C./s.

### 2. Evaluation

### (Bonding Strength)

The bonding strength between the substrate and the Si chip in the obtained bonded structure was measured by the above method. Furthermore, in any of the bonded structures, a breaking portion was in the bonding layer.

A bonded structure having a bonding strength of greater than or equal to 20 MPa was evaluated as having a high bonding strength. When the bonding strength was high, it was expressed as “high”, and when the bonding strength was low, it was expressed as “low”.

### (Remaining of First Metal Particles)

The bonding strength was evaluated by measuring at a substrate temperature of 200° C. to evaluate the heat resistance of the bonded portion. Furthermore, an image at a magnification of 3000 was captured by SEM, and when phases having different brightness were confirmed in the SEM image, energy dispersive X-ray analysis (EDX analysis) of the phases having different brightness was performed.

In the EDX analysis, when the phases having different lightness were phases composed of only the first metal, it was determined that the first metal particles remained without forming an intermetallic compound.

A bonding material having high bonding strength and no remaining first metal particles was determined to be pass.

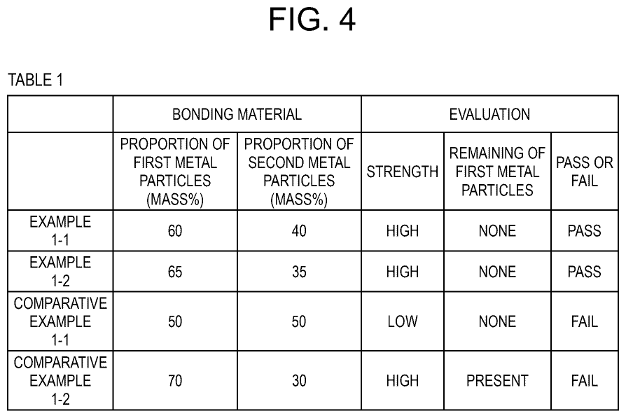

Table 1 in FIG. 4 shows proportions of the mass of the first metal particles and the mass of the second metal particles to the total mass of the metals contained in the bonding material pastes in Example 1 and Comparative Example 1, and results of the above evaluation.

### Comparative Example 1

In Comparative Example 1, with respect to the total amount of the first metal particles and the second metal particles, a proportion of the first metal particles was set to 50% and a proportion of the second metal particles was set to 50 mass % in Comparative Example 1-1, and a proportion of the first metal particles was set to 70 mass % and a proportion of the second metal particles was set to 30 mass % in Comparative Example 1-2, thereby adjusting the bonding material. A bonded structure was produced and evaluated in the same manner as in Example 1 except for the above conditions.

As is clear from Table 1 in FIG. 4, it was found that in the case of using the bonding material of the present disclosure (Examples 1-1 and 1-2), bonding can be performed with higher bonding strength than in the case of using a bonding material exceeding an upper limit of the proportion of the second metal particles (40 mass %) (Comparative Example 1-1). Furthermore, it was found that in a case where the bonding material of the present disclosure was used, the first metal particles did not remain and the heat resistance of the bonding layer was excellent as compared with the case (Comparative Example 1-2) where the bonding material below a lower limit of the proportion of the second metal particles was used.

### Example 2

In Example 2, a bonding material was adjusted by mixing the first metal particle and the second metal particle so that the total amount of the first metal particle and the second metal particle was 92 mass % of the total amount of the paste, the amount of triethanolamine as a reducing agent was 1.7 mass %, and the total amount of the organic solvent and the activator was 6.3 mass %. A bonded structure was produced and evaluated in the same manner as in Example 1 except for the above conditions.

### Comparative Example 2

As a method of manufacturing a bonding material, the surface of the first metal particles was not coated with a reducing agent, and was mixed with the second metal fine particles to adjust the bonding material so that a proportion of the composite particle was 100%. A bonded structure was produced and evaluated in the same manner as in Example 1 except for the above conditions.

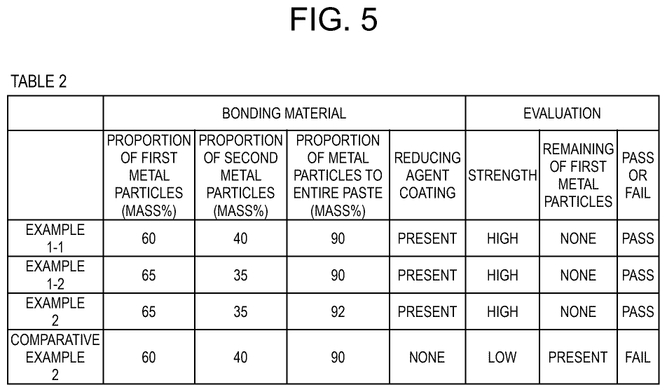

Table 2 in FIG. 5 shows proportions of the mass of the first metal particles and the mass of the second metal particles to the total mass of the metals contained in the bonding material pastes in Example 2 and Comparative Example 2, and results of the above evaluation. Note that results of Example 1-1 and Example 1-2 are also shown for comparison.

FIG. 2 illustrates a cross-sectional SEM image of the bonding material of Example 2 after heating. Furthermore, for comparison, FIG. 3 illustrates a cross-sectional SEM image of the bonding material of Comparative Example 2 after heating.

In FIG. 2, the remaining phase of the first metal is not found in the structure after bonding. In the bonded structure of Example 2, it was confirmed that the first metal and the second metal reacted with each other and the formation of the intermetallic compound proceeded well. A parent phase in FIG. 2 is composed of a CuSn alloy and a Bi phase in which the first metal and the second metal in the composite particle, and the single particle and the outermost second metal particle of the composite particle are reacted, and it is found that the parent phase is the central core of the composite particle after the spherical Bi phase is reacted. That is, it was confirmed that the composite particles were connected to each other and the bonding strength was good. On the other hand, in FIG. 3, it was confirmed that there was a remaining phase of the first metal, and the formation of the intermetallic compound did not proceed so well in the bonded structure of Comparative Example 2. Furthermore, the shape of the second metal fine particles was confirmed between the composite particles, and it was confirmed that the bonding strength was not so good.

As is apparent from Table 2 in FIG. 5, in the case of using the bonding material according to the present disclosure (Example 2), bonding can be performed with high bonding strength as compared with the case of using the bonding material in which the reducing agent component of the flux does not exist between the central core and the coating layer in the composite particle (Comparative Example 2). Furthermore, since the first metal particles did not remain, it was found that both the strength and heat resistance of the bonding layer were excellent.

### Example 3

In Example 3, the bonding material paste was adjusted so that the average particle sizes of the composite particle and the single particle of the first metal particles were different from each other. In Example 3-1, an average particle size of the first metal particles used for the composite particle was 10 μm, an average particle size of the first metal particles used for the single particle was 2 μm to 6 μm, in Example 3-2, an average particle size of the first metal particles used for the composite particle was 2 μm to 6 μm, and an average particle size of the first metal particles used for the single particle was 10 μm, and in Example 3-3, an average particle size of the first metal particles used for the composite particle was 2 μm to 6 μm, and an average particle size of the first metal particles used for the single particle was 20 μm to 38 μm. A bonded structure was produced and evaluated in the same manner as in Example 1 except for the above conditions.

### Comparative Example 3

In Comparative Example 3, an average particle size of the first metal particles used for the composite particle was set to 2 μm to 6 μm, an average particle size of the first metal particles used for the single particle was set to 45 μm to 75 μm, and a bonded structure was produced and evaluated in the same manner as in Example 1 except for the above conditions.

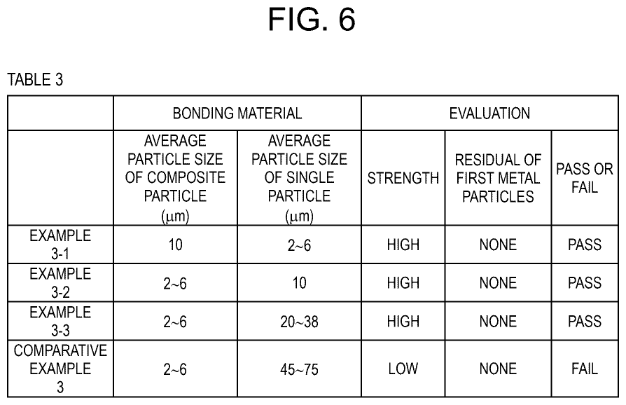

Table 3 in FIG. 6 shows average particle sizes of the composite particle and the single particle of the first metal particles in Example 3, and results of the above evaluation.

As is apparent from Table 3 in FIG. 6, in the case of using the bonding material according to the present disclosure (Examples 3-1 to 3-3), it was found that the bonding can be performed with high bonding strength as compared with the case of using the bonding material exceeding an upper limit (38 μm) of the average particle size of the single particle of the present disclosure (Comparative Example 3).

### INDUSTRIAL APPLICABILITY

According to the bonding material according to the present disclosure, it is possible to shorten a time required for bonding and to reduce thermal damage to peripheral members at the time of bonding, which is required in a device involving large heat generation such as a power device. Moreover, it is possible to prevent deterioration of meltability at the time of heating due to the use of fine particles, and to provide a bonding material excellent in strength and heat resistance of a bonding portion.

### REFERENCE MARKS IN THE DRAWINGS

101 composite particle
102 single particle

1. A bonding material comprising:
a single particle that is a particle of a first metal;
a composite particle including a central core that is a particle of the first metal, and at least one coating layer covering an entire surface of the central core, the at least one coating layer including a fine particle of a second metal; and
a flux including a reducing agent component,
wherein the first metal and the second metal have properties of forming an intermetallic compound of the first metal and the second metal, and
the reducing agent component of the flux is present between the central core and the at least one coating layer.

2. The bonding material according to claim 1, wherein the first metal is a Sn alloy.

3. The bonding material according to claim 1, wherein the second metal is Cu.

4. The bonding material according to claim 1, wherein the first metal is a Sn—Bi alloy.

5. The bonding material according to claim 4, wherein the Sn—Bi alloy includes Bi with a content at which a liquidus temperature is less than or equal to 150° C. in an equilibrium diagram of the Sn—Bi alloy.

6. The bonding material according to claim 4, wherein the Sn—Bi alloy includes Bi with a content of 52 mass % to 62 mass %.

7. The bonding material according to claim 1, wherein the fine particle of the second metal in a total mass of the single particle and the composite particle is 30 mass % to 40 mass % when the total mass is 100 mass %.

8. The bonding material according to claim 2, wherein the particle of the first metal that is the central core of the composite particle has an average particle size of 2 μm to 10 μm.

9. The bonding material according to claim 2, wherein the particle of the first metal that is the single particle has an average particle size of 2 μm to 38 μm.

10. The bonding material according to claim 1, wherein the fine particle of second metal has an average particle size of 50 nm to 500 nm.

11. The bonding material according to claim 1, wherein the reducing agent component is an alkanolamine.

12. A bonded structure comprising: an element electrode; a metal member; and the bonding material according to claim 1 that bonds the element electrode and the metal member.
